(19) United States
(12) Patent Application Publication
(10) Pub. No.: US 2008/0247165 A1
(43) Pub. Date: Oct. 9, 2008

(54) METHOD AND APPARATUS FOR INCREASING VISIBILITY OF A LASER POINTER

(75) Inventor: Mark D. Schultz, Ossining, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/696,265

(22) Filed: Apr. 4, 2007

(51) Int. Cl. G01J 3/46; G02B 27/30; F21V 23/04

(52) U.S. Cl. 362/259; 356/425; 359/641; 362/276

(57) ABSTRACT

A method and apparatus for increasing the visibility in the visible spectrum of a laser pointer on a target. The laser pointer provides a laser source or sources of at least two distinct visible colors. The visibility of at least one of the laser source colors on the target is determined. The laser source color is selected from the given colors based on the determined visibility. The selected laser source color is directed to the target.

### BACKGROUND OF THE INVENTION

1. Field of the Invention

This invention relates to a laser pointer and more particularly to a method and apparatus for increasing the visibility of the laser pointer.

2. Description of the Background

A laser pointer is a commonly available and relatively inexpensive apparatus used to identify or indicate an area or point or text or feature or zone, i.e., a target, in a projected presentation on a suitable display, typically a diffusely reflective surface. The laser pointer is generally a pen-shaped and portable and is intended to be manually held and operated. The identification or indication is the intersection of the laser beam source with the display. Commonly the color of the laser beam source is in the red or green portion of the visible spectrum. However, typically the visibility of the intersection of the laser beam source is decreased or substantially disappears where the color of the area or point or text or zone of the feature is similar to the color of the laser beam source. Both technology and safety place limits on the overall laser power that can be projected onto a display in order to increase the visibility of the intersection of the laser beam source and the display.

### SUMMARY OF THE INVENTION

The shortcomings of the visibility of the known laser pointer are overcome and additional advantages are provided through the provision of a method for increasing the visibility in the visible spectrum of a laser pointer on a target and a laser pointer for practicing the method. The method may comprise providing a laser source or sources of at least two distinct visible colors. The visibility of at least one of the given laser source colors on the target is determined. A laser source color from the given colors is selected based on the determined visibility. The selected laser source color is directed to the target.

### BRIEF DESCRIPTION OF THE DRAWINGS

The subject matter that is regarded as the invention is particularly pointed out and distinctly claimed in the claims at the conclusion of the specification, i.e., the detailed description of the invention. The foregoing and other objects, features, and advantages of the invention are apparent from the following detailed description taken in conjunction with the accompanying drawings in which:

FIG. 1 illustrates a laser pointer in accordance with one example or embodiment;

FIG. 2 illustrates a laser pointer in accordance with another example or embodiment; and

FIG. 3 illustrates a sequence for gating the laser pointer and a detector.

The detailed description explains the examples or embodiments of the invention, together with advantages or features, by way of reference to the drawings.

### DETAILED DESCRIPTION OF THE INVENTION

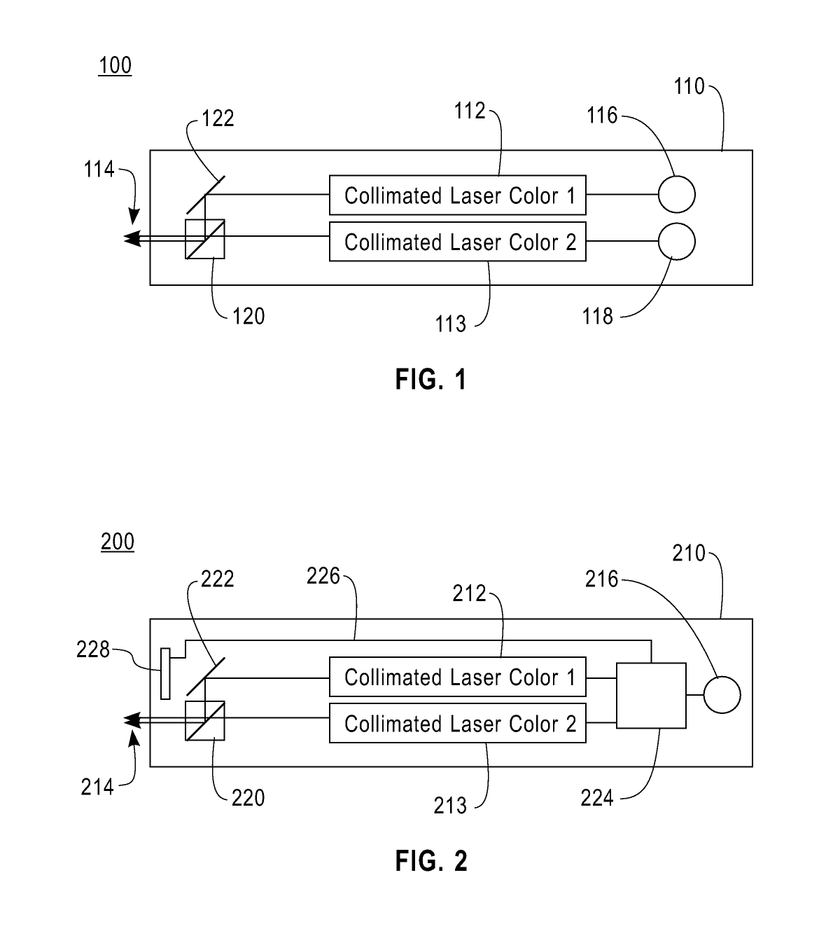

FIG. 1 illustrates a laser pointer in accordance with one example or embodiment. The laser pointer 100 comprises a laser body 110 having a collimated laser source 112 producing a beam output 114 of a color of given wavelength in the visible spectrum. For example, the color of laser source 112 can be red. The laser pointer further comprises a collimated laser source 113 producing a beam output 114 of another color of another wavelength in the visible spectrum. For example, the color of laser source 113 can be green. Switch 116 provides an on/off control of laser source 112. Switch 118 provides an on/off control of laser source 113. Alternatively, there can be a separate switch to select the wavelength and a single on/off switch. In the example or embodiment of FIG. 1, the change or selection of the laser source is controlled or caused manually by the user by operation of switches 116 and 117.

Corrective optics forming a beam combiner intercept the beam output 114 of laser sources 112 and 113. The corrective optics may comprise a mirror 122 and a filter, such as dichroic (or dielectric) filter 120. The beam output from laser source 112 can be reflected by mirror 122 to the filter 120. The beam output from laser source 113 can be transmitted directly to the filter 120. The dichroic beam combiner is intended to pass or transmit the color of laser source 113 and to reflect the color or laser source 112. Alternatively, if desired the corrective optics, such as the beam combiner, can be eliminated, and the beam output 114 from each laser source 112 and 113 is directly brought out from the front of the laser body. If the dichroic beam combiner is eliminated the laser output from both laser sources should impact substantially the same target area or point or feature or text or zone.

In operation of the example or embodiment of FIG. 1, the wavelength or color and power of the beam output of laser sources 112 and 113 can be based on real visual experiments where the user and the viewer indicate what wavelength or color and power are most visible for a range of target colors and intensities. In a typical operation, laser switches 116 and 117 can be manually operated to select the beam output 114 of laser source 112 or 113. The selected beam output is directed to a target. The target is a projected presentation or display having a predetermined color visibility and intensity. The user determines which color or wavelength of the beam output has the higher visibility with respect to the predetermined color and intensity of the target. The user causes the laser source to be selected from a given wavelength and another wavelength by operating switches 116 and 117. Alternatively, the user may determine what color or wavelength will be most visible prior to activating either laser wavelength or may do so after activating one or more of the laser sources.

FIG. 2 illustrates a laser pointer in accordance with another example or embodiment. The laser pointer 200 comprises a laser body 210 having a collimated laser source 212, e.g., a first source, producing a beam output 214 of a color of given wavelength in the visible spectrum. For example, the color of laser source 212 can be red. The laser pointer further comprises a collimated laser source 213, e.g., a second source, producing a beam output 214 of another color of another wavelength in the visible spectrum. For example, the color of laser source 213 can be green. Switch 216 provides an on/off control of laser light output from sources 212 and/or 213. It is also possible to create a third visible color if desired by having both laser sources on simultaneously.

Corrective optics forming a beam combiner intercept the beam output 214 of laser sources 212 and 213. The corrective optics may comprise a mirror 222 and a filter, such as dichroic filter 220. The beam output from laser source 212 can be reflected by mirror 222 to the filter 220. The beam output from laser source 213 can be transmitted directly through the filter 220. The dichroic beam combiner is intended to pass or transmit the color of laser source 213 and to reflect the color of laser source 212. Alternatively, if desired the corrective optics, such as the beam combiner, can be eliminated, and the beam output 214 from each laser source 212 and 213 is directly brought out from the front of the laser body. If the dichroic beam combiner is eliminated the laser output from both laser sources should impact substantially the same target area or point or feature or text or zone.

A color detection and laser selection logic and/or circuit 224 receive a feedback signal 226 from a color sensor or detector 228 that may have a narrow field of view. The color sensor or detector 228 may further comprise corrective optics, such as a focusing lens. The color detect and laser selection logic and/or circuit 224 comprises an algorithm that would compute the level (intensity) within the target area of the image of the color of laser source 212, for example, red, relative to the overall level (intensity) and choose the color of laser source 213, for example, green, when the overall level exceeds a predetermined level, for example, 30 percent. Generally, the color sensor or detector is a single or few or multi-element detector, such as a CCD type, with the detection logic 224 computing the exact area of the detector where the reflected laser output is intersecting the target in order to determine which area of the detector to utilize for computing the observed background color and intensity.

In a typical operation of the example or embodiment of FIG. 2, the beam output of either laser source 212 and 213 is directed to the target. The target is at least a portion of a projected presentation or display having a color visibility and intensity. The color sensor or detector 228 determines the target color and intensity. The color sensor or detector 228 provides a feedback signal 226 to the color detection and laser selection logic and/or circuit 224 to choose the laser source having a higher visibility with respect to the detected color and intensity of the target. The operation of the detector 224, the feedback signal 226 and the color sensor 228 can be confirmed and calibrated based on real visual experiments where the user and the viewer indicate what wavelength or color and power are most visible for a range of target colors and intensities.

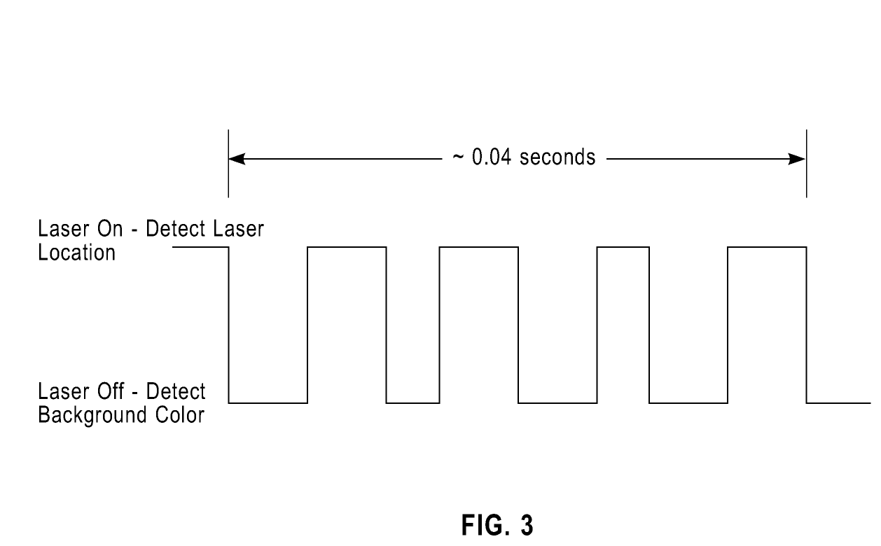

FIG. 3 illustrates a sequence for gating the laser pointer and the detector. The laser source and the detector are gated at a frequency above a detectable rate of visual and image flicker so that the detector could determine the location of the laser beam output when the beam is on, and the target color when the beam is momentarily turned off. Gating of the laser source and the detector provides for the determination of the color of the target being impacted or intersected by the beam. Gating separately detects background (target) color and laser source location. Integrating the background color determination over a period of at least approximately 0.04 seconds or preferably 0.1 seconds would likely allow target color determination even in an image that is flickering at above visual detection rates. Once the target color is determined, the wavelength or color and power most visible for a range of target colors and intensities would be chosen for the output of the laser source.

The corrective optics for either the example or embodiment of FIG. 1 or 2 may be waveguides and/or fibers, where the fibers are likely single mode. Other dispersive techniques, such as prisms or gratings, can be used instead of a dichroic. The corrective optics may allow either or both of the different wavelengths to be directed to a target display depending on the visibility of the laser output on the target.

Two laser sources are illustrated in the examples or embodiments of FIGS. 1 and 2. Alternatively and equivalently only one laser source is possible where the laser source is tunable either electronically or optically or combined with an electronically tunable filer. If a single laser source is used, the color and power level would be chosen based upon empirically determined maximum visibility for a given background. In operation a color select dial or switch can be combined with a single on/off switch.

The laser source of the example or embodiment of FIGS. 1 and 2 is typically a solid-state device. Alternatively, the laser source could be any laser that provides an output in the visible spectrum to include, for example, tunable dye lasers, gases such as He—Ne or a mixed gas of argon/krypton ion, doped glass, semiconductor diode, doped-YAG or YVO4 or Ti-sapphire. The visible spectrum beam output laser source of the example or embodiment of FIGS. 1 and 2 can be red and green; however, the choice of color is not limited to red or green. The laser source output can be other colors (and intensities) that provide a wavelength or color and power that are most visible for a range of target colors and intensities. For example, a choice of a laser source output of red and blue would have more visibility than red and orange or orange and yellow. The laser source can also include corrective optics to shape, e.g., an arrow, or focus the beam output.

While an example or embodiment of the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for increasing the visibility in the visible spectrum of a laser pointer on a target comprising:
providing a laser source or sources of at least two distinct visible colors;
determining the visibility of at least one of the given laser source colors on the target;
selecting a laser source color from the given colors based on the determined visibility; and
directing the selected laser source color to the target.

2. The method of claim 1 wherein the given colors are from more than one laser source disposed in the laser pointer.

3. The method of claim 1 wherein the determining is provided by a sensor of the color of the target; and
providing an output of the sensor to a selection circuit for selecting the laser source color.

4. The method of claim 1 comprising corrective optics disposed at an output of the laser source or sources located in the laser pointer.

5. The method of claim 4 wherein the corrective optics is a dichroic beam combiner.

6. The method of claim 1 wherein the selecting of the laser color is manually initiated.

7. The method of claim 1 wherein the selecting of the laser color is automatically initiated.

8. The method of claim 1 wherein the laser source and an output of the determining is gated at a frequency above visual flicker observation.

9. The method of claim 1 wherein one given color is in the red portion of the visible spectrum and another given color is in the green portion of the visible spectrum or vice versa.

10. The method of claim 1 comprising:
determining the level of one of the given colors within the target relative to an overall level; and
selecting another color when the level of the given color exceeds a predetermined percentage of the overall level.

11. A laser pointer comprising:
a laser source or sources providing at least two different given colors in the visible spectrum and disposed in the pointer;
corrective optics disposed at an output of the laser source or sources which allow one or more of the different colors to be directed to a target depending on visibility of the output on the target; and
means for initiating or ceasing the output of the laser source or sources.

12. The laser pointer of claim 11 wherein the corrective optics is a filter.

13. The laser pointer of claim 11 wherein the corrective optics is a dichroic beam combiner.

14. The laser pointer of claim 11 comprising:
a sensor for determining the visibility of the output of the laser sources on the target;
a circuit for gating the different colors at a frequency above visual flicker observation; and
a circuit for selecting at least one of the colors depending on the feedback from the sensor.

15. The laser pointer of claim 14 wherein the sensor comprises a multi-element detector.

16. The laser pointer of claim 11 wherein the laser source is a solid-state device.

17. The laser pointer of claim 11 wherein one of the different colors is in the red portion of the visible spectrum and wherein one of the different colors is in the green portion of the visible spectrum.

18. A laser pointer comprising:
a first laser source having an output in the red portion of the visible spectrum;
a second laser source having an output in the green portion of the visible spectrum;
a sensor for determining the visibility of the output of the laser sources on a target;
a circuit for gating the laser sources and the sensor at a frequency above flicker observation; and
a circuit for selecting only one of the laser sources depending on the output of the sensor.

19. The laser pointer according to claim 18 comprising:
a dichroic beam combiner disposed at the output of the laser sources to allow either or both of the laser sources to be directed to the target.

20. The laser pointer according to claim 18 wherein the sensor is a multi-segment color-capable detector.
